(19) United States
(12) Patent Application Publication
(10) Pub. No.: US 2010/0006587 A1
(43) Pub. Date: Jan. 14, 2010

(54) Beverage Label System and Dispenser

(76) Inventor: Charles M. Newmark, Marina Del Ray, CA (US)

Correspondence Address: EDWARD S. SHERMAN, ESQ., 3554 ROUND BARN BLVD., SUITE 303, SANTA ROSA, CA, 95403, US

(21) Appl. No.: 12/499,226

(22) Filed: Jul. 8, 2009

Related U.S. Application Data
(60) Provisional application No. 61/079,427, filed on Jul. 9, 2008.

(51) Int. Cl. G07F 11/68; G09F 3/00

(52) U.S. Cl. 221/70; 40/310

(57) ABSTRACT

A bottle label means having a hole on one side and an ID means on the other is optionally dispensed from a roll or stack by inserting the neck of the bottle into the hole whereby the removal provide another label that is ready for removal by a second bottle. Preferably, the labels are not identical so that each bottle has a unique identification on it without the need to write on the label.

### CROSS REFERENCE TO RELATED APPLICATIONS

The present application claims priority to the U.S. Provisional patent application of the same title filed on Jul. 9, 2008, having application Ser. No. 61/079,427, which is incorporated herein by reference.

### BACKGROUND OF INVENTION

The present invention relates to labels for personally marking beverage and similarly shaped bottles and a method for dispensing and applying such labels.

Prior methods of marking beverage bottles most similar to the present invention are disclosed in the following US patents and applications, which are incorporated herein by reference: U.S. Pat. No. 1,350,890 (Tanzey, Aug. 24, 1920); U.S. Pat. No. 1,971,528 (Klebanow, Aug. 28, 1934); U.S. Pat. No. D370,386 (Pallesen, Jun. 4, 1996); U.S. Pat. No. D412,938 (Kesselring et al., Aug. 17, 1999); and 2005/0138854 A1 (Simmons, Jun. 30, 2005).

However, this prior art fails to teach a means to rapidly supply such labels at the time the bottled beverages are removed from a refrigerator or other storage means and distributed to individuals.

Further, the prior art methods do not provide a convenient means for personalization. Thus, at parties and other social gatherings it is easy for unlabeled beverages to be mixed up leading to the non-hygienic sharing of the beverage containers, or the wasteful disposal of containers that are only partially consumed.

It is therefore an object of the present invention to avoid the waste of bottle and contents that occurs when the bottles are not personally identified.

It is also another object of the invention to provide an aid to hygiene via a means to rapidly add personal labels to beverage bottles and thus avoid consumption by any other than the intended recipient not associated with the label.

It is also a further object of the invention to provide labels constructions and format compatible with such a convenient and rapid dispensing and personalization means.

### SUMMARY OF INVENTION

In the present invention, the first object is achieved by providing a method for custom labeling beverage and similarly shaped bottles at the time of consumption, the method comprising the steps of providing a sequential plurality of labels in a dispending apparatus, each label in said plurality having the same exterior shape of the other of the labels and a different external appearance than the immediately adjacent labels, wherein all but the terminal label in the sequential plurality is a substantially planar and rectangular sheet that comprises; a first perforated end in contact with the preceding label, a substantially circular portion adjacent the first perforated end, and a second perforated end in contact with the following label. The next step in the process being the user grasping the first label to expose the substantially circular portion thereof distal from the other labels, followed by grasping a bottle, and then inserting the neck of the bottle through the substantially circular portion of the first label, and then thereafter detaching the first label from the subsequent label by tearing the perforated end in common there between, whereby the first label is affixed to the bottle.

In a second aspect of the invention, the perforated end of the labels is first torn and the circular portion of the now free label is inserted over the neck of the bottle.

A second aspect of the invention is characterized in that in the above method each label further comprises a partially surrounding perforation separating the substantially circular portion from a narrow peripheral portion wherein at least one of said step of inserting the neck of the bottle through the substantially circular portion of the first label and grasping the first label to expose the substantially circular portion thereof distal from the other labels tear the partially surrounding perforation whereby the narrow peripheral portion forms a ring around the neck of the bottle and the bottle and the interior thereof form a label face attached to the ring.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1A is a front elevation of a first embodiment of the dispenser with a label partially removed there from. FIG. 1B is a plan view thereof whereas FIG. 1C is a side elevation of the dispenser. FIG. 1D is a side elevation and partial cut-away view of the other side of the dispenser showing the internal positions of a stack of labels therein.

FIG. 2A is a plan view of an embodiment of the label in FIG. 1A-D. FIG. 2B is a side elevation thereof and FIG. 2C is a front elevation thereof. FIG. 2D is a plan view of the reverse side of an alternative embodiment of the label in FIGS. 1 and 2A, in which FIG. 2C is a cross-sectional elevation of a modification thereof.

FIG. 3A is a plan view of another embodiment of the label. FIG. 3B is a side elevation of the label of FIG. 3A in a partially opened state for the attachment to a bottle as shown in the side elevation in FIG. 3C. FIG. 3D is a side elevation of a plurality of the labels of FIG. 3A arranged in a continuous roll. FIG. 3E is a plan view of a portion of the roll in FIG. 3D that is partially extended.

FIG. 4 is a perspective view of the label of FIG. 3 attached to a bottle.

FIG. 5A-D illustrate another embodiment of the label dispenser for use with the continuous roll shown in FIG. 3D. FIG. 5A is a front elevation of the labels in a portion of this embodiment of the dispenser. FIG. 5B is a cross-sectional elevation, orthogonal to FIG. 5A, taken at reference line B-B in FIG. 5A. FIG. 5C is the orthogonal section corresponding to reference line C-C in FIG. 5B. FIG. 5D is a cross-sectional elevation taken at reference line D-D in FIG. 5A.

FIG. 6 is a perspective view of the dispenser in FIG. 5.

### DETAILED DESCRIPTION

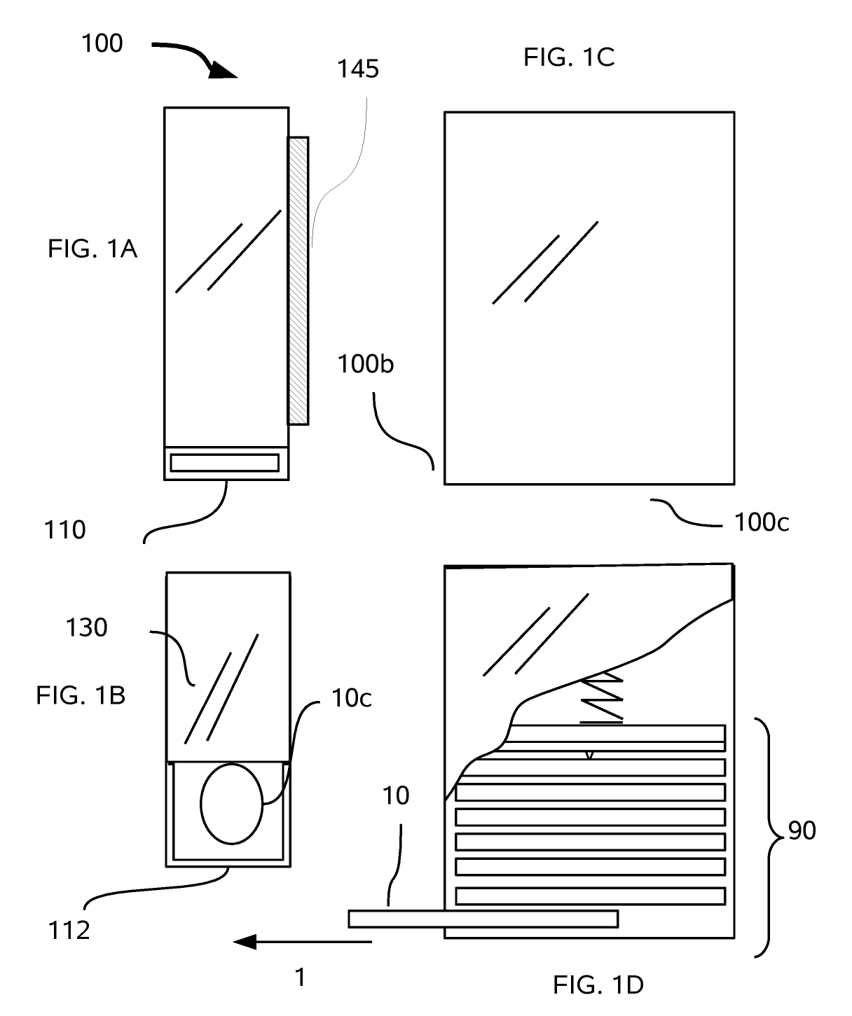

Referring to FIGS. 1 through 6, wherein like reference numerals refer to like components in the various views, there is illustrated therein a new and improved beverage label system and dispenser, generally denominated 100 herein.

In accordance with the present invention FIG. 1A-C illustrate a first embodiment in which dispenser 100 contains a plurality of labels 10, preferably arranged in a stack 90. Dispenser 100 is generally in the shape of box having six sides and a slit opening 110 at the bottom edge 100b.

A stack 90 of substantially planar labels 10 is disposed in the box shaped dispenser 100, each label 10 having an opening on side 10a and a label portion 10b on the other. The labels 10 are arranged in stack 90 with each open side 10a facing the slit 110. It should be noted that each label 10 is thinner than height of the slit 110. The open side 10a is intended to be inserted around the neck of a bottle to be personally labeled whereas the opposite side 10b is intended to bear personalizing indicia. Preferably, each label 10 in stack 90 has a different appearance than the other labels in the stack 90. This different appearance can take be in the form of one or more number(s), letter, word, color, pattern, symbols and the like. Alternatively, the user could write their name or other distinguishing characteristic on the label face 10b.

Removing a label 10 that is at the bottom of the stack 90 dispenses another label into position for removal. Optionally, dispenser 100 also includes an adhesive patch or magnet 145 on the side for attachment to a counter, refrigerator and the like.

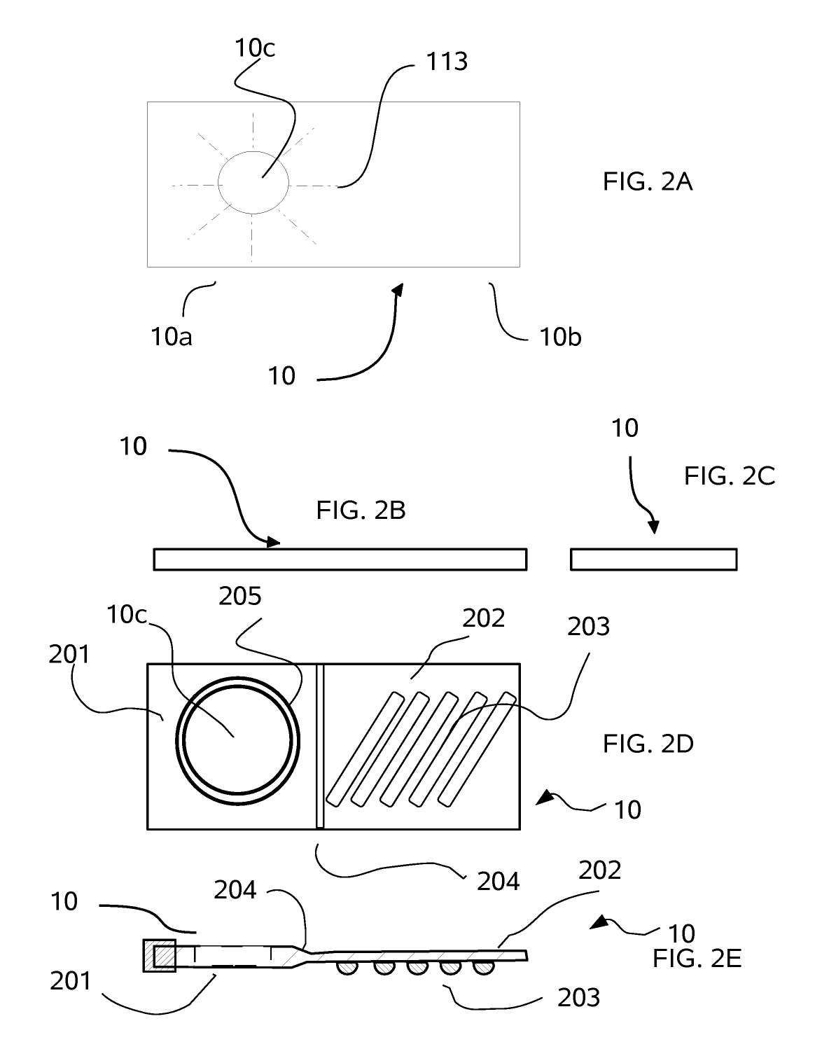

Further details of a preferred embodiment of the label 10 for use with dispenser 100 is shown in FIG. 2A-C. Preferably labels 10 have a feathered portion surrounding each opening 10c, the featured portion comprising a plurality of slits 13 that extend outward from the perimeter of the hole 10c. Each label 10 having at least one of an opening 10c and a partially circular perforation 15. The labels 10 are optionally relatively thin so as to be light and flexible, and may be constructed from paper, cardboard, or relatively tear resistant, non-woven fabric, such as “TYVEK®”, as well as any recyclable materials, and are more preferably themselves recyclable.

Other preferred embodiment of the label 10, as shown in FIGS. 2D and 2E, include providing a least a relatively rigid portion 201 to aid in sliding through the slit 110 in the dispenser 100 by a bottle neck or other means. More preferably the label 10 also has a relatively flexible portion 202, and in particular there is pressure sensitive adhesive 203 on the downward face of the label opposite the rigid portion for folding this flexible portion for attachment to the bottle. the flexible portion can be a thin groove 204 traversing the label and separating the more rigid regions, as for example in a “living hinge” where the same material is deployed over the entire label, but the grooved portion being thinner is more flexible and bends to allow the label to fold like a hinge.

The relatively rigid portion can extend to the walls of the container, to aid the sliding outward there from, having a low coefficient of friction with respect to the adjacent contacting container wall and bottom. Alternatively the relatively rigid region can be a reinforcing ring around the hole 205, or just around a portion of the edge 206. The relatively rigid portion can differ from those on the other labels in the stack, say for example by color, pattern, texture and the like.

Preferably there is at least a partial opening 112 at the bottom 100c of box 100. Preferably a spring 130 provides a means for dispensing the next label where the open side protrudes from the slit, as it asserts a force on stack 90 so that the bottom label 10′, is firmly urged against the interior of side 10c. Thus, removal of label 10′, presents the next label 10″ in position for dispensing. In one mode of use, dispensing is accomplished by inserting the neck of a bottle into the opening 10c of label 10 and so that drawing the bottle in the direction of arrow 1 will drag label 10′ through slit 110. Alternatively, one or more labels can be dispensed by hand with the opening 10c then inserted around the neck of the bottle.

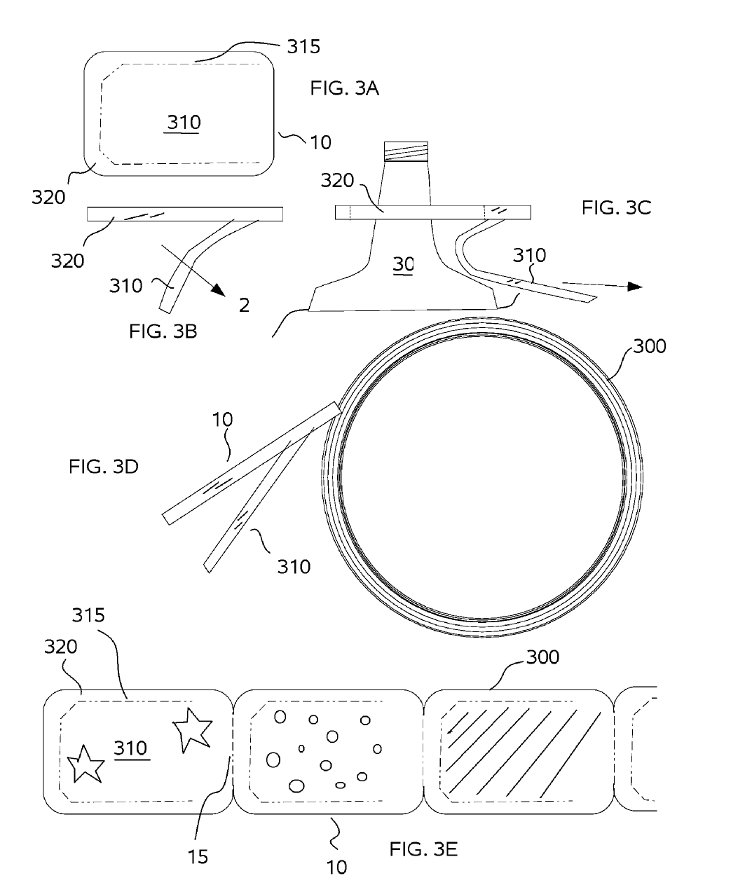

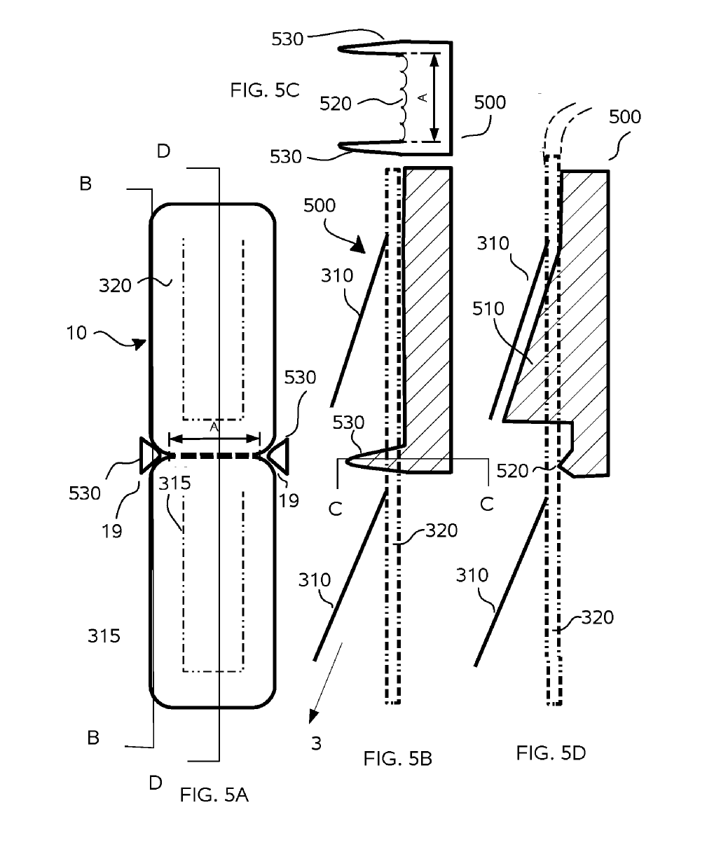

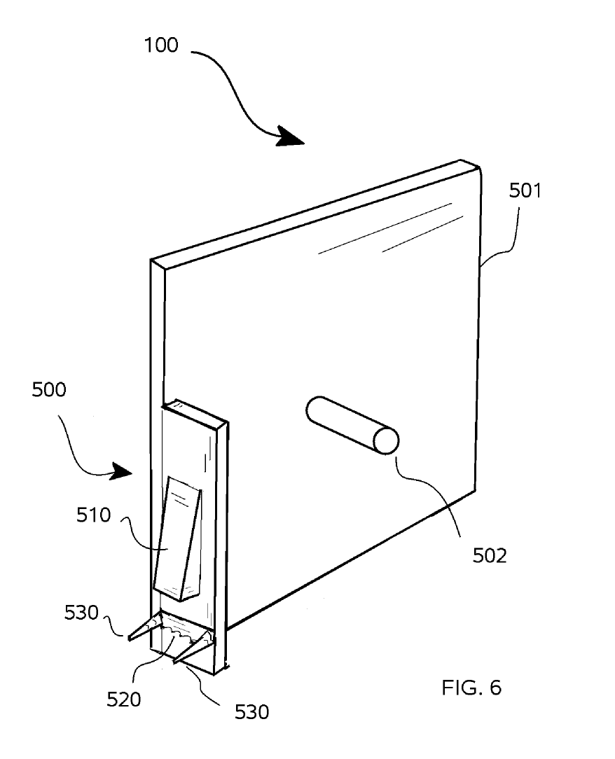

FIG. 3A-E illustrates another embodiment of the label 10, with a means for dispensing this label 10 shown in FIGS. 5 and 6.

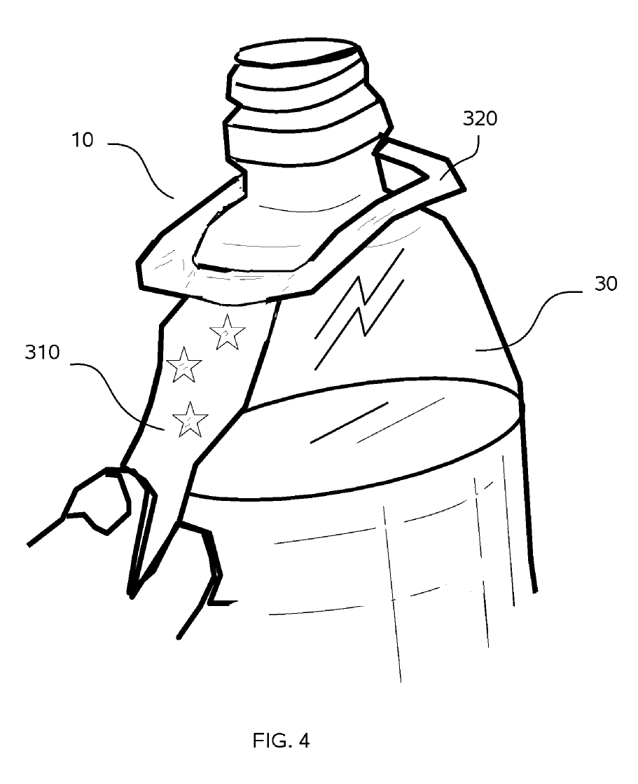

In FIGS. 3E and 3D, a continuous ribbon or tape 300 is formed by attaching a plurality of labels 10 separated by a partially perforated border 15. Each label 10 (shown in FIG. 3A) has a central tab portion 310 formed by a slit or at least partial perforations 315 in a U-shape that extends around 3 of the 4 sides that define the perimeter of label 10. Preferably the side not encompassed by slit or perforation 315 is that adjacent partially perforated border 15. When the central label portion or tab 310 is pushed away from the surrounding perimeter 320, when the tab 310 is urged in the direction of arrow 2 in FIG. 3B, the perimeter 320 then forms an open ring that can be inserted over the neck of the bottle 30 as shown in FIGS. 3C and 4.

Preferably, each label 10 in ribbon 300 has a different appearance than at least the immediately adjacent label, but more preferably every label 10 in ribbon 300. This different appearance can take be in the form of one or more number(s), letter, word, color, pattern, symbols and the like. Alternatively, the user could write their name or other distinguishing characteristic on the label face 310.

FIG. 4 shows a perspective illustration of label portion 310 fully folded backward so that loop 320 surrounds the neck of bottle 30. Optionally, the ribbon or tape 300, shown in FIG. 3D in elevation, has a pressure sensitive adhesive 203 on at least a portion such as 310 or 320 thereof to cause it to stick to bottle 30. Thus, either a release backing is also included in this spool on the side opposite the adhesive or the ribbon 300 has front surface that will not stick to the pressure sensitive adhesive 203 deployed on the back surface.

FIG. 5 illustrates an embodiment of dispenser 100 which has a spindle 502 for holding ribbon 300 when rolled onto a spool in rotary engagement for label by label dispensing that provides for the tearing of perforations 15 and the punching out label region 310 to expose ring 320. Preferably, the ribbon or roll 300 is unwound over dispensing area or plate 500 so that perforation 15 are exposed to a cutting edge 520 for tearing off each labels 10 from ribbon 300. Thus, the spindle 520 for supporting the ribbon or tape 300 as a roll on circular core extends orthogonally from a mounting plate 501, shown in FIG. 6. The dispensing area or plate 500 is also orthogonal to mounting plate 501, which includes a nose 510 for punching out label region 310, below which is mounted the cutting edge 520, which is shown in the preferred embodiment in which it is serrated, between a pair of guides 530. As shown in FIG. 5A, guides 530 extend beyond rounded triangular notch region 19 at opposite the perforation lines 15 to align perforation line 15 against cutting edge 520.

In using dispenser 100 in FIG. 5 and FIG. 6 a user first grabs hold of the protruding label 10 with the thumb and index finger, with the user pulling it towards themselves until the narrowed tear-off line 15 can fit within the opening of the serrated “cutter” blade 520. Next the user places their middle finger between label face 310 and the surrounding loop of 320. Thus, by pulling label 10 down to cut and separate the lower label from the upper label along the perforated line 15 also forces the nose 510 to push out the label region 320, before tearing perforations at line 15.

A user of reasonable dexterity can then flip and hold the label face 310 forward such that the loop 320 is open receive the neck of the bottle 30. Thus, it should be appreciated, that as in the embodiment shown in FIG. 1, the process of removing a first label exposes the ring or circular hole portion of the next label to be dispensed. Optionally, the bottle neck can be inserted into the now open loop or ring 320 and used to aid in pulling this label down to tear it at the upper connecting perforation 15 on blade 520.

U.S. Pat. No. 5,294,034, issued to Svensson on Mar. 15, 1994, which is incorporated herein by reference, discloses another a ticket dispenser believed to be generally compatible with dispensing the labels 10 in the form of a rolled tape or ribbon 300 in the preferred manner for attaching to bottles.

it should be appreciated that features, aspects and variations of the different embodiments may also be combined with those of other embodiments. As for example, the label 10 used with the dispenser 100 as shown in FIG. 2A-E, may be provided on the labels 10 shown in FIGS. 3-5, in tape or ribbon 300 for use with the dispenser 500 shown in FIGS. 5 and 6.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method for custom labeling bottles at the time of consumption, the method comprising the steps of:
a) providing a sequential plurality of labels in a dispending apparatus, each label in said plurality having the same exterior shape of the other of the labels and a different external appearance than the immediately adjacent labels, wherein all but the terminal label in the sequential plurality is a substantially planar and rectangular sheet that comprises;
i) a first perforated end in contact with the preceding label,
ii) a substantially circular portion adjacent the first perforated end, and
iii) a second perforated end in contact with the following label,
b) grasping the first label to expose the substantially circular portion thereof distal from the other labels,
c) grasping a bottle,
d) inserting the neck of the bottle through the substantially circular portion of the first label, whereby the first label is affixed to the bottle.

2. A method for custom labeling bottles at the time of consumption according to claim 1 wherein the first label is detached from the subsequent label by tearing the perforated end in common there between before inserting the neck of the bottle through the substantially circular portion of the first label.

3. A method for custom labeling bottles at the time of consumption according to claim 1 wherein the first label is detached from the subsequent label by tearing the perforated end in common there between after inserting the neck of the bottle through the substantially circular portion of the first label.

4. A method for custom labeling bottles at the time of consumption according to claim 1 wherein each label further comprises a partially surrounding perforation separating the substantially circular portion from a narrow peripheral portion wherein at least one of said step of inserting the neck of the bottle through the substantially circular portion of the first label and grasping the first label to expose the substantially circular portion thereof distal from the other labels tears the partially surrounding perforation whereby the narrow peripheral portion forms a ring around the neck of the bottle and the bottle and the interior thereof form a label face attached to the ring.

5. A method for custom labeling bottles at the time of consumption according to claim 5 wherein the partially surrounding perforation are slits that extend through the label.

6. A plurality of labels for dispensing around the neck of bottles at the time of consumption, comprising:
a) a sequential plurality is a substantially planar and rectangular sheet that comprises;
i) a first perforated end in contact with the preceding label,
ii) a substantially circular portion adjacent the first perforated end, and
iii) a second perforated end in contact with the following label,

7. A plurality of labels for dispensing around the neck of bottles at the time of consumption according to claim 6 wherein the substantially circular portion adjacent the first perforated end is defined by at least a series of partial perforations having a general U-shape that is torn and folded outward to form an open ring for inserting on the neck of a bottle.

8. A plurality of labels for dispensing around the neck of bottles at the time of consumption according to claim 6 wherein each label in said plurality has the same exterior shape of the other of the labels and a different external appearance than the immediately adjacent labels.

9. A plurality of labels for dispensing around the neck of bottles at the time of consumption according to claim 7 wherein each label in said plurality has the same exterior shape of the other of the labels and a different external appearance than the immediately adjacent labels.

10. A plurality of labels for dispensing around the neck of bottles at the time of consumption according to claim 6 wherein the partially surrounding perforation are slits that extend through the label.

11. A label dispenser comprising:
a) a container having;
i) a planar bottom that is partially open and upright surrounding sidewalls,
ii) a slit that penetrates the portion of the side wall adjacent the open portion of the planar bottom, the slit extending the width of the container,
b) a plurality of planar labels disposed inside said container that extend to substantially the lateral dimensions thereof, each label has at least one of an internal opening and an internal region the region capable of at least one of opening or widening in response to a normal force, the opening or region penetrating from the bottom to the top of the plane thereof, wherein the opening is disposed above the open portion for the planar bottom of the container.

12. A label dispenser according to claim 11 wherein the internal opening is a circular hole.

13. A label dispenser according to claim 11 wherein the region capable of at least one of opening in response to a normal force is a hole having a series of perforation or slits extending outward from the periphery thereof, the perforation or slits extending through the plan of the planar label.

14. A label dispenser according to claim 11 wherein the internal region capable of widening in response to a normal force is a series outward radiating perforation or slits extending from the center of the region, the perforation or slits extending through the plan of the planar label.

15. A label dispenser according to claim 11 wherein each label has a pressure sensitive adhesive applied to the downward face thereof.

16. A label dispenser according to claim 11 wherein the upward face of each label is different from the upward face of every other label in the container.

17. A label dispenser according to claim 11 wherein each label has a relatively rigid portion to aid in sliding out of the slit when urged forward by a bottle neck at least partially inserted in the opening or region.

18. A label dispenser according to claim 11 wherein each label has a relatively pliable region to attaching to the sidewall of a bottle.

19. A label dispenser according to claim 18 further comprising pressure sensitive adhesive applied to the downward face of the relatively pliable region for attaching to the sidewall of a bottle.

20. A label dispenser according to claim 11 further comprising a cover and a spring to exert a downward force on the stack of the labels therein.
